(19) United States
(12) Patent Application Publication
(10) Pub. No.: US 2020/0010733 A1
(43) Pub. Date: Jan. 9, 2020

(54) ADHESIVE ARTICLE

(71) Applicant: 3M INNOVATIVE PROPERTIES COMPANY, St. Paul, MN (US)

(72) Inventors: John C. Hulteen, Afton, MN (US); Martin J. Widenbrant, Stillwater, MN (US)

(21) Appl. No.: 16/470,278

(22) PCT Filed: Dec. 13, 2017
(86) PCT No.: PCT/US2017/066064

§ 371 Date: Jun. 17, 2019

Related U.S. Application Data
(60) Provisional application No. 62/437,785, filed on Dec. 22, 2016.

(51) Int. Cl. C09J 7/38; C09J 7/20; C09J 9/00; C09K 21/14; E04B 1/94

(52) U.S. Cl. CPC C09J 7/385; C09J 7/387; C09J 7/20; C09J 2453/00; C09K 21/14; E04B 1/948; C09J 2433/00; C09J 9/00

(57) ABSTRACT

Described herein is an adhesive article for fire protection along with methods of using the same. The adhesive article comprises (i) a substrate having a major surface, wherein the major surface has at least two opposing distal portions and a central portion therebetween and wherein the substrate is perforated along the at least two opposing distal portions and is not perforated in the central portion; (ii) a sealing strip positioned between the central portion and the distal portion; and (iii) a discontinuous adhesive layer disposed on the at least two opposing distal portions.

### TECHNICAL FIELD

An adhesive article is described along with a method of use for fire protection.

### SUMMARY

Building codes for commercial structures (e.g., apartments, office buildings) generally require a passive fire protection system to contain and/or slow the spread of a fire. Fire-resistant materials such as walls and doors are used. However, there are openings between walls and floors, and even openings within the walls and floors, that must be sealed to contain and/or slow the spread of fire.

Traditionally, caulking, putty, or spray foam are used to seal the openings. However, these materials can be labor intensive to apply and the quality and appearance of the final seal is often dependent on the skill level of the person applying it. Thus, there is a desire to identify alternative fire protection materials that can be used to seal openings, which may allow advantages in ease of use, range of use, and/or aesthetics.

In one aspect, an adhesive article is provided, the adhesive article comprising (i) a substrate having a major surface, wherein the major surface has at least two opposing distal portions and a central portion therebetween and wherein the substrate is perforated along the at least two opposing distal portions and is not perforated in the central portion; (ii) a sealing strip positioned between the central portion and the distal portion; and (iii) a discontinuous adhesive layer disposed on the at least two opposing distal portions.

In another aspect, a method of fire protecting an opening is disclosed, the method comprising: sealing the opening with the adhesive article as described herein, wherein the central portion is positioned over the opening and the discontinuous adhesive layer is used to fixedly attach the adhesive article to the perimeter of the opening, wherein a sealing strip is located between the opening and the perforated distal portion of the adhesive article.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

The figures disclosed below are representative embodiments of the present disclosure and are not drawn to scale.

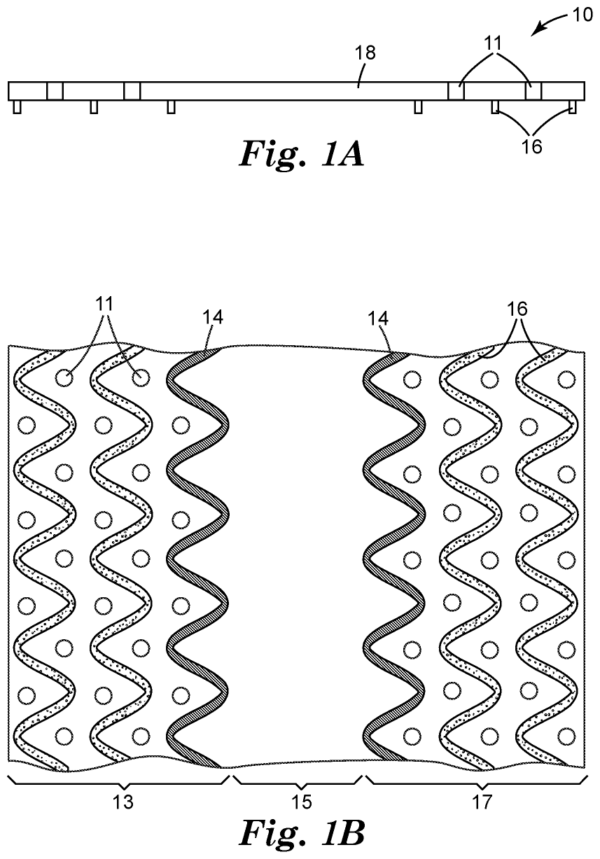

Shown in FIG. 1 is a schematic of a cross section (1A) and planar view (1B) of one embodiment of an adhesive article of the present disclosure;

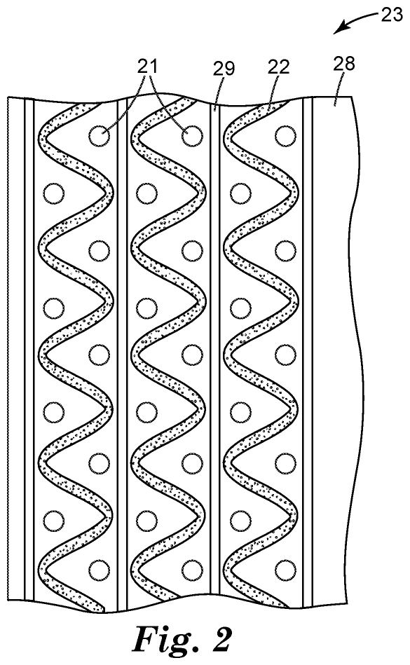

Shown in FIG. 2 is a schematic view of a distal portion according to one embodiment of an adhesive article of the present disclosure;

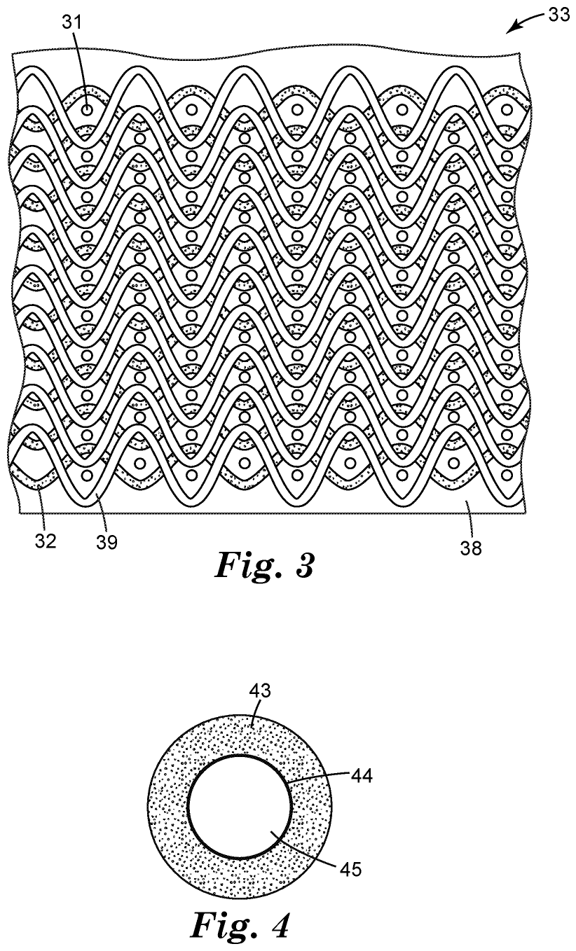

Shown in FIG. 3 is a schematic view of a distal portion according to one embodiment of an adhesive article of the present disclosure;

Shown in FIG. 4 is a top view of one side of an adhesive article disclosed herein;

Shown in FIG. 5 is a side-view of one side of a wall comprising an exemplary joint system of a wall-to-wall joint disclosed herein;

Shown in FIG. 6 is a side-view of one side of a wall comprising an exemplary joint system of a wall-to-wall joint disclosed herein;

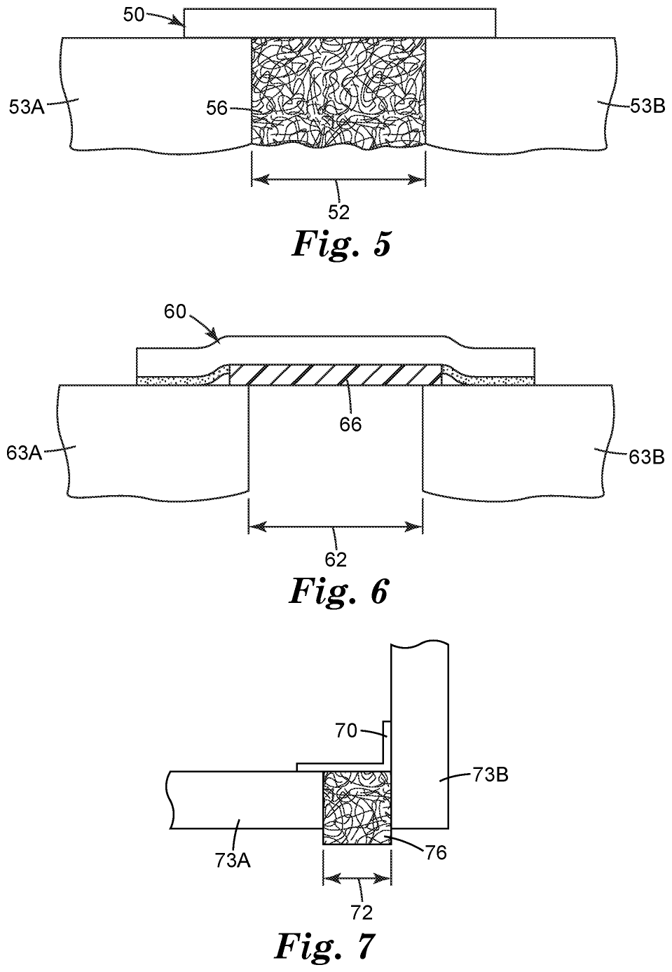

Shown in FIG. 7 is a side-view of one side of a wall comprising an exemplary joint system of a 90 degree joint disclosed herein;

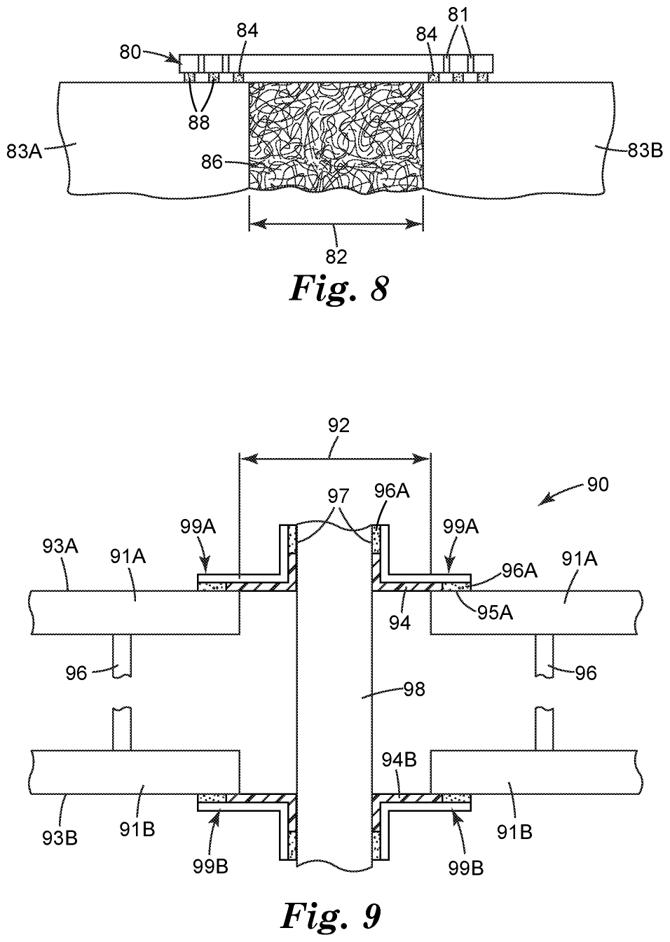

Shown in FIG. 8 is a side-view of one side of a wall comprising an exemplary joint system of a wall-to-wall joint disclosed herein; and

Shown in FIG. 9 is a side-view of a firestop system disclosed herein comprising a through penetration.

### DETAILED DESCRIPTION

As used herein, the term
“construction assembly” refers to a building construction such as a wall or floor comprising two opposing major surfaces wherein each major surfaces comprises a structural element;
“penetration” refers to an opening (or hole) which intersects a major surface of a construction assembly to allow for access to the interior of the construction assembly or to enable the passage of penetrating objects through the construction assembly;
“penetrating object” refers to a physical item that passes through the penetration and extends beyond the surface of the construction assembly. Such penetrating objects include cables, conduits, ducts, pipes, etc.);
“membrane penetration” refers to a penetration located on only one major surface of the construction assembly;
“through penetration” refers to construction assembly having a through hole wherein there are penetrations on both opposing major surfaces of the construction assembly;
“blank” refers to a penetration in a construction assembly that does not have a penetrating object;
“a”, “an”, and “the” are used interchangeably and mean one or more; and
“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed toward an adhesive article. Such adhesive articles can be used in the treatment of openings within buildings to contain and/or slow the spread of fire.

In one embodiment, openings such as joints, voids, gaps, or other discontinuities between two or more adjacent structural elements are present in buildings to accommodate building movements. Movements can occur between the adjacent structural elements, for example due to loads, heat, wind, and seismic events. These openings are sometimes referred to as dynamic joints, since they change (expand and contact or flex) over time. These openings are often between walls, between floors, or where a wall and floor (or ceiling) meet. A fire-resistant joint system can be achieved by applying the adhesive articles disclosed herein to a joint. As used herein, fire-resistant means that the joint system can, for a period of time, withstand the heat intensity (under conditions of a fire) and not structurally fail or allow the cold side of the joint to become hotter than a given temperature (e.g., about 200° C). .

Alternatively, in one embodiment, the opening is within a particular structural element (such as a wall or floor). Construction assemblies such as horizontal and vertical assemblies (e.g., floors, walls, and ceilings) have a required fire rating based on the construction materials and building code requirements. Sometimes openings are present in the walls, ceilings, and floors to allow for penetrating items (such as cables, pipes, ducts, conduits, etc.) through the building. Once an opening is made into the construction assembly, the fire-rating is compromised. The purpose of a firestop is to restore the fire-rating back to the original rating of the construction assembly.

Additionally, nominal openings between structural elements, such as static joints, can be treated, which can help contain and/or slow the spread of fires.

In one embodiment, the adhesive articles of the present disclosure may be used to treat the above described openings.

The adhesive articles of the present disclosure can be understood with respect to FIGS. 1A and 1B, which show a cross-section and bottom view, respectively, of adhesive article 10. The first major surface of substrate 18 comprises central portion 15 and opposing distal portions 13 and 17. Substrate 18 is perforated in distal portions 13 and 17 as shown by holes 11. Central portion 15 is not perforated. Adhesive article 10 comprises sealing strips 14 located between central portion 15 and distal portions 13 and 17. A discontinuous adhesive layer is disposed on the first major surface. Shown in FIGS. 1A and 1B are adhesive strips 16 which are disposed on opposing distal portions 13 and 17.

The substrate of the adhesive article of the present disclosure (also known in the adhesive arts as a backing) may be selected from a polymeric film, a paper, a metallic sheet, a foam, and combinations thereof. Exemplary substrates include polyolefins such as polyethylene, polypropylene (including isotactic polypropylene), polystyrene, polyester (such as poly(ethylene terephthalate) and poly(butylene terephthalate)), polyvinyl alcohol, poly(caprolactam), poly(vinylidene fluoride), polylactides, cellulose acetate, ethyl cellulose, and the like. Commercially available backing materials useful include Kraft paper (available from Monadnock Paper, Inc.); cellophane (available from Flexel Corp.); spun-bond poly(ethylene) available under the trade designation “TYVEK” (available from DuPont, Inc.); and spunbond poly(propylene) available under the trade designation Fitesa Spunbond (available from Fitesa Inc.), and films obtained from poly(ethylene) and poly(propylene), available under the trade designation “TESLIN” (available from PPG Industries, Inc.), and “CELLGUARD” (available from Hoechst-Celanese).

The substrate can be selected based on the application. The substrate should be stable (i.e., does not auto-ignite or distort) at temperatures of at least 80° C., 85° C., 90° C., 93° C., 95° C., 98° C., 100° C., 150° C., 180° C., or even 200° C. In one embodiment, the substrate has some flexibility allowing the adhesive article to absorb some of the movement (e.g., in a dynamic joint or between a structural element and a penetrating object) and/or the pressure experienced from a fire hose. In one embodiment, a polyolefin substrate is selected due to its resistance to humidity changes.

As mentioned above, the substrate comprises a central portion and at least two opposing distal portions. The central portion of the substrate is nonporous, meaning that it does not allow for convective flow of gas or smoke. However, the distal portion of substrate is perforated (or comprises holes). These perforations may be of any shape (rhombus, triangular, circular, irregular, etc.). Typically these perforations have an area of at least 0.008, 0.05, 0.1, 0.2, 0.4, 0.6, or even 0.8 mm². The perforations may be large so long as the adhesive article is structurally stable (i.e., the backing has enough structural stability to be handled and applied to a structural element). In one embodiment, the distal portion of the substrate has a % open area of at least 0.01, 0.1, 0.5, 1, 5, 10, 20, or even 30% and no more than 50, 60, or even 70%.

The width of the central portion and distal portions can vary based on the application. In fire protection use, as will be described in more detail below, the central portion of the substrate is used to cover the opening, while the distal portions are fixedly attached to the structural element(s). Thus, the central portion should have a width (or size) which covers the opening, while the distal portions should be of a sufficient width to maintain adherence of the article to the structural element(s).

In one embodiment the central portion is at least 0.25, 0.5, 1, 2, 4, 6, 10, or even 12 inches (6.4, 12.7, 25.4, 50.8, 102, 152, 254, or even 305 mm) in width. In one embodiment, the width of the distal portion extending perpendicular from the edge of the substrate inward toward the central portion is at least 6, 10, 12, or even 20 mm and generally no more than 50, 75, 100, 150, or even 200 mm.

### Adhesive Layer

An adhesive layer is disposed on the substrate. Other layers as known in the adhesive art may be present, such as a primer layer located between the substrate and the adhesive and/or a coating (e.g., ink or low-adhesive backsizing) located on the second major surface of the substrate, opposite the adhesive layer, which is located on the first major surface of the substrate.

Adhesive materials useful in the present disclosure include those that allow adhesion to a variety of construction surfaces, including, for example, concrete, metal (e.g., aluminum or steel), and gypsum wallboard. Adhesive materials suitable for the practice of the present disclosure include polymers of silicones, acrylics, alpha olefins, ethylene/vinyl acetate, urethanes, and natural or synthetic rubbers. In one embodiment, the adhesive is a pressure sensitive adhesive.

Suitable urethane resins include polymers made from the reaction product of a compound containing at least two isocyanate groups (—N═C═O), referred to herein as “isocyanates”, and a compound containing at least two active-hydrogen containing groups. Examples of active-hydrogen containing groups include primary alcohols, secondary alcohols, phenols, and water. A wide variety of isocyanate-terminated materials and appropriate co-reactants are well known, and many are commercially available for example, polyurethane dispersion based PSA's from Dow Chemical Co. Also see, for example, Gunter Oertel, “Polyurethane Handbook”, Hanser Publishers, Munich (1985)).

In one embodiment, active-hydrogen compounds containing primary and secondary amines can react with an isocyanate to form a urea linkage, thereby forming a polyurea.

Suitable acrylic resins include acrylic pressure sensitive adhesives (PSAs). Acrylic PSAs comprise polymers of one or more (meth)acrylate ester monomers, which are monomeric (meth)acrylic esters of a non-tertiary alcohol, wherein the alcohol contains from 1 to 20 carbon atoms and preferably an average of from 4 to 14 carbon atoms.

Examples of monomers suitable for use as the (meth)acrylate ester monomer include the esters derived from either acrylic acid or methacrylic acid and non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 3,7-dimethylheptanol, 1-decanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof. In one embodiment, the (meth)acrylate ester monomer is present in an amount of 80 to 99 parts by weight based on 100 parts total monomer content used to prepare the polymer. Preferably (meth)acrylate ester monomer is present in an amount of 90 to 95 parts by weight based on 100 parts total monomer content.

The (meth)acrylic polymer further comprises a polar comonomer. For example, an acid group-containing comonomer. Examples of suitable acid-group containing monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl (meth)acrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. In one embodiment, the acid functional monomer is generally used in amounts of 0 to 10 parts by weight, preferably 1 to 5 parts by weight, based on 100 parts by weight total monomer of the adhesive.

Other polar monomers may also be polymerized with (meth)acrylate ester monomer to form the polymer. Representative examples of other suitable polar monomers include, but are not limited to, 2-hydroxyethyl (meth)acrylate; N-vinylpyrrolidone; N-vinylcaprolactam; acrylamide; mono- or di-N-alkyl substituted acrylamides, such as for example t-butyl acrylamide, dimethylaminoethyl acrylamide, and N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates and mixtures thereof. Exemplary polar monomers include those selected from the group consisting of 2-hydroxyethyl (meth)acrylate and N-vinylpyrrolidone. In one embodiment, the other polar monomer may be present in amounts of 0 to 10 parts by weight, preferably 1 to 5 parts by weight, based on 100 parts by weight total monomer of the adhesive.

When used, vinyl monomers useful in the (meth)acrylate polymer include: alkyl vinyl ethers (e.g., vinyl methyl ether); vinyl esters (e.g., vinyl acetate and vinyl propionate), styrene, substituted styrene (e.g., a-methyl styrene), vinyl halide, and mixtures thereof. Such vinyl monomers are generally used at 0 to 5 parts by weight, preferably 1 to 5 parts by weight, based on 100 parts by weight total monomer.

In order to increase cohesive strength and improve the performance at elevated temperatures of the adhesive article, a multifunctional (meth)acrylate (comprising more than more acrylate group) may be incorporated into the blend of polymerizable monomers. Multifunctional acrylates are particularly useful for emulsion or syrup polymerization. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof. The amount and identity of multifunctional (meth)acrylate is tailored depending upon application of the adhesive composition. Typically, the multifunctional (meth)acrylate is present in amounts less than 5 parts based on based on 100 parts by weight total monomer. In one embodiment, the multifunctional (meth)acrylate may be present in amounts from 0.01 parts to 1 part based on 100 parts total monomers of the adhesive composition.

Optional co-monomers can be used to tailor the performance of the PSA. Optional co-monomers include those having at least two different reactive groups e.g., 2-OH (meth) acrylate and glycidyl (meth)acrylate.

In one embodiment, the (meth)acrylic polymer can be crosslinked with thermal cross-linking agents, which are activated by heat, and/or photosensitive crosslinking agents, which are activated by ultraviolet (UV) light. Useful photosensitive cross-linking agents include: multifunctional (meth)acrylates, triazines, and combinations thereof. Exemplary crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590 (Vesley). Various other crosslinking agents with different molecular weights between (meth)acrylate functionality may also be useful.

In one embodiment, glycidyl (meth)acrylate may be used as a thermal crosslinking agent to provide functionality to the adhesive, which can be activated upon or after application in the field. For example, when the adhesive article is exposed to an elevated temperature, (e.g., a fire) the epoxy group of the glycidyl (meth)acrylate may react to provide further crosslinking, which can further increase the cohesive strength and increase the temperature resistance.

Suitable silicone resins include moisture-cured silicones, condensation-cured silicones, and addition-cured silicones, such as hydroxyl-terminated silicones, silicone rubber, and fluoro-silicone. Examples of suitable commercially available silicone PSA compositions comprising silicone resin include Dow Corning's 280A, 282, 7355, 7358, 7502, 7657, Q2-7406, Q2-7566 and Q2-7735; General Electric's PSA 590, PSA 600, PSA 595, PSA 610, PSA 518 (medium phenyl content), PSA 6574 (high phenyl content), PSA 529, PSA 750-D1, PSA 825-D1, and PSA 800-C. An example of two-part silicone resin commercially available is that sold under the trade designation “SILASTIC J” from Dow Chemical Company, Midland, Mich.

Pressure sensitive adhesives (PSAs) can include natural or synthetic rubbers such as styrene block copolymers (styrene-butadiene; styrene-isoprene; styrene-ethylene/butylene block copolymers); nitrile rubbers, synthetic polyisoprene, ethylene-propylene rubber, ethylene-propylene-diene monomer rubber (EPDM), polybutadiene, polyisobutylene, butyl rubber, styrene-butadiene random copolymers, and combinations thereof.

Additional pressure sensitive adhesive include poly(alpha-olefins), polychloroprene, and silicone elastomers. In some embodiments, polychloroprene and silicone elastomers may be preferred since polychloroprene contains a halogen, which can contribute towards flame resistance, and silicone elastomers are resistant to thermal degradation.

In one embodiment, the pressure sensitive adhesives may also contain one or more conventional additives. Preferred additives include tackifiers, plasticizers, foaming agents, dyes, antioxidants, and UV stabilizers.

In some embodiments, a tackifying agent may be required to provide the desired adhesive characteristics to the adhesive. Styrene block copolymers or (meth)acrylic polymers may include a suitable tackifying resin. Suitable tackifiers include rosin acids, rosin esters, terpene phenolic resins, hydrocarbon resins, and cumarone indene resins. The type and amount of tackifier can affect properties such as tack, bond strength, heat resistance, and specific adhesion. Exemplary tackifiers include: hydrogenated hydrocarbons available under the trade brands “REGALITE” and “REGALREZ”, by Eastman Chemical Co., Middelburg, Netherlands; and “ARKON” by Arakawa Chemical Inc., Chicago, Ill.; glycerin rosin ester available under the trade designation “FORAL 85” from Eastman Chemical Co., Kingsport, Tenn.; hydrocarbon or rosin types are available under the series “ESCOREZ” from ExxonMobil Chemical, Houston, Tex.; hydrocarbon resins available under the series trade designation “WINGTACK” from Cray Valley, Exton, Pa.; and terpene phenolic tackifiers available under the trade designation “SYLVARES TP96” from Arizona Chemical, Jacksonville, Fla.

In one embodiment, the pressure sensitive adhesive may contain a plasticizer, which can help soften the adhesive, and as a result, the structural element is more easily wetted by the adhesive. Further, the use of a plasticizer may improve the adhesive properties, including peel. The plasticizer may be hydrophobic and/or hydrophobic.

In one embodiment, the pressure sensitive adhesive is selected from at least one of an acrylic copolymer and a tackified styrene block copolymer.

The adhesive should have such properties that allow the adhesive article to move as necessary. For example, in one embodiment, dynamic joints fastened with the adhesive article must pass the tests for movement as described in ASTM E1399/E1399M-97 (2013) “Standard Test Method for Cyclic Movement and Measuring the Minimum and Maximum Joint Widths of Architectural Joint Systems”.

In one embodiment, the adhesive has a 90° peel strength according to ASTM D6252/6252M-98 (2011) at a strain rate of 12 inches/minute of at least 0.7, 0.8, 1, 1.5, or even 2 lb/in on the structural element such as gypsum wallboard and/or concrete. However, the acceptable peel strength can be dependent upon the overlap (or attachment area) of the adhesive article to the construction material. For example, with larger adhesive overlaps, lower peel strengths may be acceptable; whereas with smaller attachment overlaps, higher peel strengths may be necessary.

The adhesive is applied at a thickness sufficient to adhere the adhesive article to a building's structural elements. The thickness of the adhesive typically ranges from about 2 mil (50 micrometers) to about 30 mil (762 micrometers). A thick layer of adhesive material may be desirable for some applications, for example so that the adhesive material conforms to an irregular surface of the structural element (e.g., concrete). Preferably, the adhesive forms a layer with sufficient adhesion between the adhesive article and the structural element. The time required for the adhesion to develop may vary due to humidity and/or the structural element's temperature at time of application.

The adhesive layer is disposed on a first major surface of the substrate on the at least two opposing distal portions. The adhesive layer may be disposed across the first major surface, including the central portion as well as the distal portions. The adhesive layer located on the central portion may be used to fixedly attach a high-temperature resistant material.

The adhesive layer, disclosed herein is discontinuous in the distal portions of the substrate. The discontinuous adhesive layer may be discontinuous across the width and/or the length of the distal portion. In one embodiment, at least 20, 25, or even 30% and no more than 40, 45, 50, 55, or even 70% of the distal portion of the substrate is covered with adhesive. If not enough adhesive is used, then the adhesive article will not stay affixed to the structural element. If too much adhesive is used, then water originating from gypsum wallboard is unable to be transported away from the gypsum wallboard, potentially resulting in failure of the adhesive article during a Fire Test. Exemplary discontinuous adhesive layers include strips of adhesive as shown in FIG. 1B, or patterned dots of adhesive.

In one embodiment, the adhesive is applied to the substrate in a non-continuous way in order to leave parts, zones, or spots of the distal portion of the first major surface of the substrate uncoated with adhesive. In one embodiment, strips of adhesive are applied along the distal portion of the substrate as shown in FIG. 1B. Such a method is described in WO 2015/126645 (Maier, et al.), herein incorporated by reference. These strips may be straight, curved, or broken in nature. In one embodiment, more than 1 pattern of adhesive may be used. For example a first pattern of adhesive and a second pattern of adhesive may be used, wherein the first and second adhesive may or may not overlap. For example, FIGS. 2 and 3 are enlarged views of a distal portion of the adhesive article. In FIG. 2, distal portion 23 comprises substrate 28, which has been laid with a sinusoidal pattern of first adhesive 22 and striped lines of second adhesive 29. Perforations 21 in the substrate are not covered by adhesive. In FIG. 3, distal portion 33 comprises substrate 38, which has been laid with a sinusoidal pattern of first adhesive 32, which is overlapped with a sinusoidal pattern of second adhesive 39. The first and second adhesive may be the same or different. In one embodiment, the first and second adhesive are formulated so as to particularly adhere advantageously to two distinct surface conditions. In one embodiment, the first and second adhesive are formulated to have different tack, wherein the two adhesives work at different temps, for example a high tack pressure sensitive adhesive that initially adheres the adhesive article to the structural elements and a low tack pressure sensitive adhesive which has better adhesion over time or better adhesion at high temperatures.

In one embodiment, patterned dots of adhesive are applied at least to the two distal portions of the first major surface of the substrate. In addition to the patterned dots having a certain patterned nature, the dots may have a random or pseudo random pattern. In one embodiment, the pattern of dots is periodic (i.e., not random and having an order to it). The unit repeat, i.e., the area consuming the repeat pattern may have a triangular, quadrilateral (e.g., square, rhombus, rectangle, parallelogram), hexagonal, or other repeat pattern shape, which may be symmetric or asymmetric in nature.

In one embodiment, filaments of pressure sensitive adhesive are applied to the first major surface of the substrate. In addition to the filaments having a variable length, the filaments may have a random or pseudo random pattern. See for example, WO Publ. No. 2012078826 (Peterson).

Preferably, the central portion of the substrate's major surface is centrally located along the axis of the adhesive article as shown in FIG. 1B, with adhesive layers located on either side of the central portion. The adhesive layers are used to affix the adhesive article to the structural element(s). In some embodiments, the central portion may not be centrally located, however, a sufficient amount of adhesive layer must be present of either side of the central portion to affix the adhesive article to the structural element(s).

The adhesive article comprises sealing strips located between the central and at least two distal portions. In fire protection applications, these sealing strips are used to prevent leakage of gas and smoke from the fire side of the construction opening to the opposing side (cold side) of the construction. In one embodiment, these sealing stripes are an adhesive as disclosed herein.

The adhesive articles of the present disclosure can be used as a firestop and/or to slow the spread of a fire. In use, the central portion of the adhesive article is place over the opening to be sealed. The opposing distal portions of the adhesive article are placed on either side of the opening. The sealing strip is placed such that it contacts the structural element around the perimeter of the opening, sealing the opening and minimizing a stack effect (i.e., movement of air resulting from pressure, temperature, and/or moisture differences). These stack effects can lead to potential spreading of combustion products (e.g., flame, and/or hot gases including smoke, and heat) from one area to another throughout the building. A packing material, as described later, is used in conjunction with the adhesive article to create a thermal barrier between the fireside of the wall and the adhesive article.

The adhesive articles of the present disclosure can be advantageously used in construction applications that have gypsum wallboard. Gypsum wallboard, or drywall, is a building material, which consists of a core of gypsum plaster, comprising a hemihydrate of calcium sulfate, which is typically sandwiched between two layers of paper. Gypsum can have up to 20 percent bound water based upon its chemical structure. This water is chemically bound and is not normally available, except when the gypsum wallboard is exposed to elevated temperatures such as in a fire. As will be shown in the Examples disclosed herein, when an adhesive article is used as a firestop and/or to control the spread of a fire, the adhesive article is sufficient to withstand the fire. However, upon the application of pressure with a fire hose, the paper facing of the gypsum wallboard may separate from the gypsum plaster core, causing failure. Not wanting to be limited by theory, it is believed that when the surface of a gypsum wallboard is covered with a non-porous and non-permeable tape, in some instances, the tape traps the escaping moisture which is absorbed into the surface paper, saturating the paper, and the paper/tape composite will lose adhesion to the gypsum plaster core. It is believed that the perforations in the distal portions, which are attached to the structural element(s) (such as gypsum wallboard), allow water to escape from between the adhesive article and the gypsum wallboard, which can prevent the paper facing of the gypsum wallboard from becoming water saturated and separating from the gypsum core. The perforations are located on the distal portions of the adhesive article, which adhere to the structural element (e.g., wall), however there are no perforation in the central portion of the adhesive article which covers the opening.

The adhesive layer is used to fixedly attach the adhesive article to the structural element(s), however, it is believed that the adhesive also provides some structure or space between the surface of the structural element (e.g., gypsum wallboard) and the substrate such that vapor from the structural element can escape during fire conditions. This spacing between the gypsum wallboard and the substrate not covered by adhesive can be especially important when the % open area of the perforations is less than 1%, 5%, or even 10%. In one embodiment, the distal portion of the substrate comprises areas free of perforations and free of adhesive. The discontinuous adhesive layer disposed on the distal portions should not substantially coincide with the perforations, as they may block the perforations, preventing the escape of water vapor.

In one embodiment, the adhesive article can be used in a roll format, sheet, or a die cut shape. The adhesive article can be used with extended lengths, as shown in FIG. 1B, wherein the adhesive layer is disposed on two distal portions of the first major surface of the substrate with the central portion therebetween. Such extended lengths of adhesive article of the present disclosure could be used, for example, to treat joints, and head-of-wall and wall-to-wall joints. In one embodiment, the extended lengths are at least 1, 5, 8, 10, 20, or even 25 meters. In one embodiment, the adhesive article may be provided in smaller pre-cut units, where the central portion is centrally-located on a portion of the adhesive article with the perforated distal portion framing (or surrounding) the non-perforated central portion. For example, as shown in FIG. 4, non-perforated central portion 45, which surrounded by sealing strip 44 and distal portion 43. Distal portion 43 comprises perforations and a discontinuous adhesive layer. Such articles could be used to treat, for example, a penetration in a wall.

In one embodiment, the adhesive article of the present disclosure comprises a liner, which is removed from the adhesive side of the adhesive article prior to application to the structural element(s). A liner is a temporary support that is not intended for final use of the adhesive article and is used during the manufacture or storage to support and/or protect the adhesive article. A liner is removed from the adhesive article prior to use. Such liners are known in the art.

In the present disclosure, the optional liner may be used opposite the substrate, with the adhesive sandwiched therebetween. Alternatively, the substrate may be coated with a release coating on its second major surface side opposite the discontinuous adhesive layer.

To facilitate easy removal from the adhesive layer, the liner and release coating comprise a release agent. Such release agents are known in the art and are described, for example in “Handbook of Pressure Sensitive Adhesive Technology,” D. Satas, editor, Van Nostrand Reinhold, New York, N.Y., 1989, pp. 585-600. In one embodiment, the release agent migrates to the surface (on the liner or release coating) to provide the appropriate release properties.

Examples of release agents include carbamates, silicones and fluorocarbons. Preferred release agents are carbamates having relatively high softening points. Carbamates having long side chains have relatively high softening points and thus are particularly suitable in the present disclosure. A particularly preferred release agent for use in the present disclosure is polyvinyl octadecyl carbamate, available from Anderson Development Co. of Adrian, Mich., marketed as ESCOAT P20, and from Mayzo Inc. of Norcross, Ga., marketed in various grades as RA-9511, RA-95HS, RA-155 and RA-585S.

Illustrative examples of surface applied (i.e, topical) release agents include polyvinyl carbamates such as disclosed in U.S. Pat. No. 2,532,011 (Dahlquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polvurea block copolymers such as are disclosed in European Appin. No. 250,248 (Leir et al.), etc.

### Use

In one embodiment, the adhesive articles of the present disclosure are used to treat openings in structural elements of buildings to contain and/or slow the spread of fire.

Discussed below are two different ways that the adhesive article of the present disclosure may be used with a thermal barrier material.

In one embodiment, the opening in a structural element is packed with a packing material and sealed with the adhesive articles of the present disclosure. FIG. 5 depicts an exemplary configuration of a joint system of the present disclosure between two parallel elements of one side of a construction assembly (e.g., a wall). First structural element 53A and second structural element 53B have a space (i.e., opening) 52 therebetween. Space 52 is at least partially filled with packing material 56. Adhesive article 50 is applied over space 52, such that the central portion is located over space 52 and the distal portions of the adhesive article are positioned on the first and second structural elements 53A and 53B. The sealing strip is positioned over the first and second structural elements 53A and 53B, sealing opening 52.

The packing material of the present disclosure is a high-temperature resistant material, as is known in the art (e.g., a material being thermally stable up to a temperature of at least about 150° C., 200° C., 300° C., 400° C., or even 500° C.). Exemplary high-temperature resistant material include ceramic fiber, glass fiber, mineral fiber (also known as mineral wool, basalt, or rock wool), intumescent and endothermic packing materials, and combinations thereof. These materials may be used as fabrics, mats, bats, sheets, or loose fill.

Exemplary ceramic fibrous materials include ceramic oxide fibers such as small diameter melt-blown aluminosilicate ceramic fibers commercially available, for example, under the trade designations “FIBERFRAX DURABACK BLANKET” from Carborundum Co. of Niagara Falls, N.Y., and aluminosilicate fibers commercially available, for example, under the trade designations “CERAWOOL” and “KAOWOOLII” from Thermal Ceramics of Augusta, Ga.; and ceramic oxide fibers commercially available, for example, from the 3M Co. under the trade designation “NEXTEL” (e.g., aluminosilicate ceramic oxide fibers, aluminoborosilicate ceramic oxide fibers commercially available under the trade designation “NEXTEL 312”, and alumina ceramic oxide fibers commercially available under the trade designation “NEXTEL 610”). Exemplary mineral wool (such as, mineral wool derived from blast furnace slag having the major components silica, calcia, alumina, and magnesia) include those available, for example, under the trade designation “THERMOFIBER” from U.S. Gypsum of Chicago, Ill. Exemplary blends include, for example, a blend of mineral wool and glass fiber available under the trade designation “3M Fire Barrier Packing Material PM4” available from 3M Co., St. Paul, Minn.

In one embodiment, the packing material is constructed from intumescent materials or from endothermic materials. Intumescent materials are materials that when exposed to heat or flames, expand typically at exposure temperatures above about 150° C. or even above about 200° C., producing an insulating and ablative char, which serves as a barrier to heat, smoke, and flames. Exemplary intumescent material include polymeric binders, fillers, and intumescent particles (e.g., silicates, expanding graphite, and vermiculite) such as those known in the art. Endothermic materials absorb heat and are used to shield construction components from the effects of high temperatures. Useful endothermic mat materials are available, for example, under the trade designation “INTERAM MAT E-5” from 3M Co. St. Paul, Minn. These high temperature resistant materials are generally sufficiently flexible to conform to complex shapes and to conform to dimensional changes due to movement in a dynamic joint.

The packing material of the present disclosure can have resilient properties which permit the material to be pressure fit in the joint. Typically, the packing material is installed in compression (e.g., 50% compression) to maximize fiber density and prevent loss of fit due to e.g., sagging or slipping.

In one embodiment, when filling the joint space, the packing material is added such that it is in a compressed state at the space's nominal width. The depth of packing (i.e., the distance the packing material fills beginning from the first outer surface and extending into the wall cavity) for the packing material can depend on the desired rating and the thermal resistance of the packing material as is known in the art. For example, for a wall having 1.25 inches (31.8 mm) of gypsum wallboard and a 3.5 inch (88.9 mm)-wide joint (opening), a 2 hour fire-rating is achieved when filling the wall to full depth with mineral wool, whereas the 2 hour fire-rating can be achieved by using half or less than half of the fill depth with ceramic fiber. The joint space can be packed with the packing material at its full depth (i.e., the entire length between the two walls) for maximum fire-rating (e.g., longest time) or a fraction thereof, which may result in a lower fire-rating.

Instead of packing the opening with a packing materials, in another embodiment, an intumescent material is placed over the opening and the opening is sealed with the adhesive articles of the present disclosure. In one embodiment, an intumescent material is fixedly attached to the adhesive articles disclosed herein. The thickness of the intumescent material can depend on the desired rating and the thermal resistance of the intumescent material as is known in the art. In one embodiment, the thickness of the intumescent material is at least 0.1, 0.125, 0.25, or even 0.5 inch (2.4, 3.1, 6.4, or even 12.7 mm); and at most 0.6, 0.75, 0.825, or even 1 inch (15, 19, 21, or even 25.4 mm).

FIG. 6 depicts an exemplary configuration of a joint system of the present disclosure between two parallel elements of one side of a construction assembly (e.g., a wall). First structural element 63A and second structural element 63B have a space (i.e., opening) 62 therebetween. Adhesive article 60, comprising intumescent material 66 is applied over space 62, such that the central portion of the adhesive article is located over space 62 and the distal portions of the adhesive article are positioned on the first and second structural elements 63A and 63B. The sealing strip is positioned over the first and second structural elements 63A and 63B, sealing opening 62.

As shown in FIG. 5, the adhesive article of the present disclosure is fixedly attached to the construction comprising a first and second structural element, such that the adhesive article is flush against the structural elements' surface in a wall-to-wall or floor-to-floor joint. Shown in FIG. 7, is an exemplary embodiment of a joint system of the present disclosure in a joint formed by two structural elements approximately at 90 degrees from one another, such as in wall-to-floor or head-of-wall joint. First structural element 73A is approximately at 90 degrees from second structural element 73B, forming space 72. Packing material 76 fills space 72 and adhesive article 70 is fixedly attached to both structural elements.

### Dynamic Joints

In one embodiment, the adhesive articles of the present disclosure are used to treat dynamic joints to form a fire-resistant joint system. The joint system comprises a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other. The adhesive article of the present disclosure is positioned such that the central portion of the adhesive article is placed over the space and the distal portion is fixedly attached to the first attachment area and the second attachment area.

FIG. 8 depicts an exemplary configuration of a joint system between two parallel elements of one side of a construction assembly (e.g., a wall). First structural element 83A and second structural element 83B have a space (i.e., opening) 82 therebetween. Packing material 86 is fit into space 82. Adhesive article 80 is applied over space 82, wherein the adhesive article is fixedly attached via the discontinuous adhesive layer 88 to the first and second structural element. Perforations 81 are located in the distal portion, away from opening 82. Sealing strips 84 seal the opening 82, preventing gas and smoke from traveling from the opening to an adjacent space.

Typically the structural elements are capable of moving independently of one another. Thus the size of space (e.g. 82) can vary as the first structural element flexes relative to the second structural element due to thermal changes, wind, seismic activity, etc. The space between the structural elements is often referred to as a linear opening, because the length of the opening is at least 10 times greater than the width of the opening. The width of the opening may vary from its nominal joint width (i.e., the specified or installation width) ranging from a minimum joint width to a maximum joint width. The nominal width of the joint can vary depending of where the joint is located, for example, in the interior or the perimeter of the construction, with the perimeter wall generally having a larger nominal width. In one embodiment, a nominal width is at least 0.125, 0.25, 0.5, 0.75, 0.825, or even 1 inch (3.1, 6.4, 12.7, 19, 21, or even 25.4 mm); and at most 2, 3, 4, or even 5 inches (50.8, 76.2, 101.6, or even 127 mm), having a compression/expansion of at least 1%, 2%, 5%, or even 7%; and at most 20%, 25%, 30%, 40%, 50%, or even 55% of the nominal width. For example, if the nominal width is 1 inch, a compression/expansion at 25% would be 0.75 inches in compression to 1.25 inches in expansion. In one embodiment, e.g., a perimeter wall, the nominal width is at least 2, 3, or even 5 inches (50.8, 76.2, or even 127 mm); and at most 8, 9, 10, or even 11 inches (203, 229, 254, or even 279 mm), having a compression/expansion of at least 1%, 2%, 5%, or even 7%; and at most 20%, 25%, 30%, 40%, 50%, 55%, or even 60% of the nominal width.

In one embodiment of the present disclosure, the joint system, comprising the joint assembly (e.g., first and second structural elements), and the adhesive article of the present disclosure is fire-resistant. Wherein fire-resistant means that the joint system can, for a period of time, withstand the heat intensity (under conditions of a fire) and not structurally fail or allow the cold side of the joint to become hotter than a given temperature (e.g., about 200° C.). In one embodiment, the joint system passes a fire-rating test such that the joint system meets the desired fire-rating. In one embodiment, the adhesive article of the present disclosure seals the opening and the seal is not compromised during the shifting of the first and second structural elements relative to one another.

In one embodiment, the fire-resistant joint system is a fire-rated joint system, which passes an approved regiment of testing. Such tests include: ASTM method E2307-15 “Standard Test Method for Determining Fire Resistance of Perimeter Fire Barriers Using Intermediate-Scale, Multi-story Test Apparatus”; ASTM method E1966-07 “Standard Test Method for Fire-Resistive Joint Systems”; and the UL (Underwriters Laboratory) standard 2079-2008 (R2012) “Standard for Safety Tests for Fire Resistance of Building Joint Systems”. UL 2079 is similar to ASTM E1966 having a fire endurance test as well as a hose stream test, but also includes optional tests for air leakage and water leakage. Other tests includes: CAN/ULC “Standard Method of Fire Tests of Firestop Systems”; EN1366-4:2006 +A1:2010 “Fire Resistance Tests for Service Installations- Linear Joint Seals”; BS 476 Part 20 (1987): “Fire Tests on Building Materials and Structures”; AS 1530.4-2005 “Methods of Fire Tests on Building Materials, Components, and Structures Part 4: Fire Resistance Test of Elements of Construction”; and ISO 10295-2:2009 “Fire Tests for Building Elements and Components—Fire Testing of Service Installations—Part 2: Linear Joint (Gap) Seals”.

To pass an approved fire-resistant test, the joint systems of the present disclosure need to withstand a defined temperature profile (for example, exceeding temperatures greater than 700° C.) for a period of time (as described in the standards). In one embodiment, the joint systems of the present disclosure pass a flexibility test, wherein the joint system is expanded and contracted for a given number of cycles. In one embodiment, the joint systems of the present disclosure need to pass a hose stream test, wherein a stream of water at a given pressure and time (as described in the standards) is delivered onto the joint system after a fire endurance test. The joint system is then rated based on the outcome of the tests. For example, if there are no failures at 1 hour following the test methods, the joint system is then rated for 1-hour. In one embodiment, the fire-resistant joint system of the present disclosure withstands the approved regiment of testing for a period of at least 30 minutes, at least 1 hour, at least 2 hours, or even at least 4 hours.

As mentioned above, the UL standard 2079 also includes an optional air leakage test (ability of the system to withstand pressure differentials) and water leakage test (ability of the system to withstand intermittent water exposure, e.g., rain, standing water, spills, etc.), which can then result in an L rating and W rating, respectively.

In one embodiment, the systems of the present disclosure pass ASTM E1966-07, E2307-15, and/or UL 2079-2008. In one embodiment, the systems of the present disclosure also pass the optional air leakage test and/or the water leakage test of UL 2079-2008 (R2012).

### Penetrations

In one embodiment, the adhesive articles of the present disclosure are used to treat penetrations (or openings) within construction assemblies to make a firestop. The construction assembly comprises a first major surface and an opposing second major surface and further comprises a first opening which intersects the first major surface. The first major surface further comprises a first attachment area located about the perimeter of the opening The adhesive article of the present disclosure is positioned such that the central portion of the adhesive article is placed over the opening and the distal portion is fixedly attached to the first attachment area.

In some embodiments, a penetrating object having a second attachment area passes through the first penetration and extends beyond the first major surface of the construction assembly. In these embodiments, the adhesive article of the present disclosure is positioned such that the central portion is placed over the opening and the distal portion is fixedly attached to the first attachment area and the second attachment area.

FIG. 9 depicts an exemplary configuration of a firestop system of the present disclosure. System 90 includes a construction assembly comprising structural elements 91A and 91B supported by stud 96 comprising through penetration 92. Through penetration 92 intersects first major surface 93A and opposing second major surface 93B. Penetrating object 98 passes through the construction assembly via penetration 92. Adhesive article 99A and 99B, comprising an intumescent material fixedly attached to the central portion is applied such that intumescent material 94A and 94B is placed over penetration 92 around penetrating object 98. First major surface 93A comprises a first attachment area 95A around the perimeter of the penetration. Penetrating object 98 comprises a second attachment area 97 around its perimeter near the intersection of the penetration with first major surface 93A. Adhesive article 99A is fixedly attached via adhesive layer 96 to first attachment area 95A and second attachment area 97, sealing the first major surface of the construction assembly. Similarly, adhesive article 99B is fixedly attached to second major surface 93B and penetrating object 98, sealing strips (not shown) are used to seal the second major surface of the construction assembly. In one embodiment, penetrating object 98 is not made from gypsum wallboard and thus, the distal portion of the adhesive article disposed onto penetrating object 98 need not be perforated. In other words, if connecting to a non-gypsum material (such as concrete, metal, plastic, etc.), only the distal portion of the adhesive article disposed onto the gypsum wallboard would need to have the perforations disclosed herein. From manufacturing and installation ease, at least two distal portions of the substrate comprise perforations.

Depicted in FIG. 9 is penetrations occurring along the face of a planar surface of a construction assembly, which encompass a majority of the penetrations in the construction industry. However, in one embodiment, a penetration can occur at the meeting of two structural elements that may be at an angle relative to each other, such as penetration in a floor-to-wall or head-of-wall.

When the system comprises a penetrating object, in one embodiment, the adhesive article can withstand the differential movement of the penetrating object relative to the construction assembly in non-fire conditions due to, for example, expanding and contracting of the penetrating object and shifting of the penetrating object relative to the construction assembly.

In one embodiment, the system comprising the construction assembly and the adhesive article of the present disclosure is fire-resistant. Wherein fire-resistant means that the system can, for a period of time, withstand the heat intensity (under conditions of a fire) and not structurally fail or allow the cold side of the structure to become hotter than a given temperature (e.g., about 200° C.). In one embodiment the firestop system of the present disclosure passes a fire-rating test such that the system meets the desired fire-rating. It is also an objective in the present disclosure that in one embodiment, the adhesive article seals the penetration and is the assembly comprises a penetrating object, the seal not be compromised during the shifting of the penetrating object and the construction assembly relative to one another during non-fire conditions.

These penetrations can occur at various locations and numbers along a construction assembly. The shape (circular, oblong, rectangular, etc.) and width of the opening can vary. In one embodiment, the length of the smallest dimension of the opening is at least 0.125, 0.25, 0.5, 0.75, 0.825, 1, 2, 3, 4, or even 5 inch (3.1, 6.4, 12.7, 19, 21, 25, 51, 76, 102, or even 127 mm); and at most 16, 48, or even 60 inches (406, 1219, or even 1524 mm). Typically, in the larger opening dimensions, a penetrating object is present and will consume a portion of the opening Therefore, the amount of the penetration requiring sealing with the adhesive article will be a portion of the dimension of the penetration. For example, a wall comprising a 2 inch diameter circular opening with a 1.5 inch diameter pipe therethrough would require sealing of the opening in the wall around the perimeter of the pipe (about 0.25 inches around the outside of the pipe).

The penetrating objects can be made from a variety of materials commonly used in the construction industry including, for example, metal, glass, fiberglass, and plastic (including polyethylene, polypropylene, polyvinyl chloride, and fluorinated plastics such as polytetrafluoroethylene (PTFE)).

In one embodiment, the construction assembly comprising the adhesive article is a fire-rated system, which passes an approved regiment of testing. Such tests include: ASTM method E814-13a “Standard Test Method for Fire Tests of Penetration Firestop Systems and the UL (Underwriters Laboratory) standard 1479 (R2012) “Fire Tests of Through-Penetration Firestops”. UL 1479 is similar to ASTM E814 having a fire endurance test as well as a hose stream test, but also includes optional tests for air leakage and water leakage. Other tests include CAN/ULC-S115-11 “Standard Method of Fire Tests of FireStop Systems”; EN 1366-3:2009 “Fire Resistance Tests for Service Installations—Penetration Seals”; AS 1530.4-2005 “Methods of Fire Tests on Building Materials, Components and Structures Part 4: Fire Resistance Test of Elements of Construction”; ISO 834-11: 2014 “Fire Resistance Test—Elements of Building Construction-Part 11: Specific Requirements of the Assessment of Fire Protection to Structural Steel Elements”; BS 476 Fire Tests; and ISO 10295-1:2007 “Fire Tests for Building Elements and Components—Fire Testing of Service Installations—Part 1: Penetration Seals”.

To pass an approved fire test, the firestop systems of the present disclosure (comprising the construction assembly, the penetration, the adhesive article, and the penetrating object, if present) need to withstand a defined temperature profile (for example, exceeding temperatures greater than 700° C.) for a period of time (as described in the standards). In one embodiment, the systems of the present disclosure need to pass a hose stream test, wherein a stream of water at a given pressure and time (as described in the standards) is delivered onto the system after the fire endurance test. The system is then rated based on the outcome of the tests. For example, if there are no failures at 1 hour following the test methods, the system is then rated for 1-hour. In one embodiment, the fire-resistant system of the present disclosure withstands the approved regiment of testing for a period of at least 30 minutes, at least 1 hour, at least 2 hours, or even at least 4 hours.

According to ASTM E814 there are two ratings for a firestop system. An F rating is based on when a flame occurrence on the cold side of the wall (the surface away from the fire). A T rating is based on the temperature rise as well as the flame occurrence on the cold side of the wall. These rating are used, along with the presence and type of a penetrating object and the location of the opening, to evaluate the firestop system's performance.

As mentioned above, the UL standard 1479 also includes an optional air leakage test (ability of the assembly to withstand pressure differentials) and water leakage test (ability of the assembly to withstand intermittent water exposure, e.g., rain, standing water, spills, etc.), which can then result in an L rating and W rating, respectively.

In one embodiment, the assemblies of the present disclosure pass ASTM E814 and/or UL 1479. In one embodiment, the assemblies of the present disclosure also pass the optional air leakage test and/or the water leakage test of UL 1479.

In the present disclosure, the construction assembly can comprise a membrane penetration or a through penetration. As is known in the art and described in industry standard test methods, if the assembly has a symmetric through penetration only one side of the assembly is tested to determine the rating. However, if the assembly comprises a membrane penetration or an asymmetric through penetration, then each side (front and back) of the assembly is independently tested to ensure that the wall or floor is restored back it its original rating and/or meets the desired building requirements.

### Other Openings

The adhesive articles of the present disclosure can be used to treat almost any opening in a building's construction besides the dynamic joints and penetrations described above. For example, the adhesive articles of the present disclosure may be used to treat the nominal space between two abutting gypsum boards, concrete block, or other wall, ceiling or floor construction materials.

The intumescent material or packing material is used as a thermal barrier to maintain the integrity of the substrate. The sealing strip of the adhesive article seals the opening. When using an intumescent tape, the intumescent material should snugly fit, and more preferably overlap the opening. In one embodiment, the intumescent material is about the same width as the opening. In one embodiment, the intumescent material overlaps the opening by at least 0.25, 0.5, or even 0.75 inches (6.4, 12.7, or even 19 mm) on either side; and at most 1, 2, or even 4 inches (25.4, 50.8 or even 101.6 mm).

The distal portion should sufficiently overlap the structural elements to maintain contact with the structural elements and maintain a seal over the lifetime of the joint. In one embodiment, the adhesive overlaps the opening by at least 0.25, 0.5, 0.75, 1, 2, or even 4 inches (6.4, 12.7, 19, 25.4, 50.8, or even 101.6 mm) on either side; and at most 6 or even 12 inches (152.4 or even 304.8 mm). In other words, the adhesive contacts the first attachment area by at least 0.25 inches (6.4 mm) and the second attachment area by at least 0.25 inches (6.4 mm). The acceptable overlap of the adhesive with the attachment areas can depend on the nature of the structural element (e.g., concrete versus gypsum); adhesive used (e.g., the 90 degree peel strength as mentioned above); and/or the flexibility of the substrate (e.g., more overlap needed for substrates that are not as flexible).

Heretofore the means for sealing such joints has been to insert an insulation batting or to spray foam, putty, or caulk into the joint gap. Using an adhesive article as disclosed herein for a fire protection article has advantages over the putties, caulks and spray coatings, including the ability to use over a broader working range (for example, at temperatures below 4° C. and in wet conditions) with little preparation of the structural elements, and ease of use (i.e., rolling a strip of tape down a wall wherein the adhesive is contained in the adhesive article).

The system of the present disclosure is rated for protection of the “cold side” of the structure (e.g., wall or floor). In other words, the side of the wall away from the fire. Since, one cannot predict which side of the wall a fire will occur, in practical use, the adhesive article of the present disclosure can be used on both openings of the wall as shown in FIG. 9. For example, during a fire on Side A, adhesive article 99A may burn or melt in the fire. Although not wanting to be limited by theory, it is believed that intumescent material 94A and 94B act as a thermal barrier helping to minimize the temperatures experienced by the substrate on the cold side of the wall. It is also believed that adhesive article 99B acts as a barrier minimizing the potential spreading of combustion products from one area to another throughout the building.

It has been discovered that the adhesive articles of the present disclosure provide a fire-resistant system or even a fire-rated system, fire-rated for 30 minutes, 1 hour, 2 hours, or even 4 hours. This is surprising because as mentioned above, the fire-rated system must meet the fire test and water hose test. In dynamic applications, such as in dynamic joints and penetrating objects, the adhesive article must also have the ability to flex with movement (e.g., building or penetrating object) and have long term durability (e.g., 20 years, 30 years or even 40 years). Furthermore, construction sites are typically thought of as dirty, with dust, dirt, etc. In one embodiment, the adhesive articles disclosed herein can be applied to the structural elements without clean-up or priming of the structural elements.

Embodiments which are useful for understanding the present disclosure include, but should not be limited to the following:

Embodiment 1. An adhesive article, the adhesive article comprising:
(i) a substrate having a major surface, wherein the major surface has at least two opposing distal portions and a central portion therebetween and wherein the substrate is perforated along the at least two opposing distal portions and is not perforated in the central portion;
(ii) a sealing strip positioned between the central portion and the distal portion; and
(iii) a discontinuous adhesive layer disposed on the at least two opposing distal portions.

Embodiment 2. The adhesive article of embodiment 1, wherein the discontinuous adhesive layer is disposed on the central portion.

Embodiment 3. The adhesive article of any one of the previous embodiments, wherein an intumescent material is fixedly attached to the central portion.

Embodiment 4. The adhesive article of embodiment 3, wherein the intumescent material is fixedly attached via the discontinuous adhesive layer.

Embodiment 5. The adhesive article of any one of the previous embodiments, wherein the at least two opposing distal portions have an open area of at least 0.01%.

Embodiment 6. The adhesive article of any one of the previous embodiments, wherein the discontinuous adhesive layer comprises at least two different adhesives patterns.

Embodiment 7. The adhesive article of any one of the previous embodiments, wherein the discontinuous adhesive layer comprises at least two different adhesives.

Embodiment 8. The adhesive article of any one of the previous embodiments, wherein the perforations are patterned.

Embodiment 9. The adhesive article of any one of the previous embodiments, wherein the perforations are substantially free of the discontinuous adhesive layer.

Embodiment 10. The adhesive article of any one of the previous embodiments, wherein the discontinuous adhesive layer comprises at least one of an epoxy, an acrylic, a urethane, a silicone, and a rubber.

Embodiment 11. The adhesive article of any one of the previous embodiments, wherein the discontinuous adhesive layer is a pressure sensitive adhesive.

Embodiment 12. The adhesive article of any one of the previous embodiments, wherein the discontinuous adhesive layer comprises at least one of (i) an acrylic adhesive and (ii) a styrene block copolymer and a tackifier.

Embodiment 13. The adhesive article of any one of the previous embodiments, wherein the substrate is selected from a polymeric film, a paper, a metallic sheet, a foam, and combinations thereof.

Embodiment 14. The adhesive article of any one of the previous embodiments, wherein the central portion is at least 6 mm wide.

Embodiment 15. The adhesive article of any one of the previous embodiments, wherein the opposing distal portions are each at least 6 mm wide.

Embodiment 16. The adhesive article of any one of the previous embodiments, wherein the adhesive article is an extended length.

Embodiment 17. The adhesive article of embodiment 16, wherein the extended length is at least 5 meters.

Embodiment 18. The adhesive article of any one of the previous embodiments, wherein the central portion is framed by a perforated distal portion.

Embodiment 19. The adhesive article of any one of the previous embodiments, further comprising a liner, wherein the liner is disposed on the discontinuous adhesive layer opposite the substrate.

Embodiment 20. The adhesive article of any one of the previous embodiments, wherein the substrate comprises a release coating on the second major surface of the substrate opposite the discontinuous adhesive layer.

Embodiment 21. A method of fire protecting an opening, the method comprising:
sealing the opening with the adhesive article of any one of embodiments 1-20, wherein the central portion is positioned over the opening and the discontinuous adhesive layer is used to fixedly attach the adhesive article to the perimeter of the opening, wherein a sealing strip is located between the opening and the perforated distal portion of the adhesive article.

Embodiment 22. The method of embodiment 21, wherein the seal is generated by the discontinuous adhesive layer.

Embodiment 23. The method of any one of embodiments 21-22, wherein the opening is a space between two structural elements.

Embodiment 24. The method of embodiment 23, wherein the space between the two structural elements is less than 6 mm.

Embodiment 25. The method of embodiment 24, wherein the space between the two structural elements is more than 12 mm.

Embodiment 26. The method of any one of embodiments 21-22, wherein the opening is a hole in a wall or floor.

Embodiment 27. The method of embodiment 26, wherein the opening comprises a through penetration.

Embodiment 28. The method of embodiment 27, wherein the through penetration is a duct, a pipe, or a conduit.

Embodiment 29. A method of attaching a fire resistant joint system to a dynamic joint in a structure, the dynamic joint including a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other, the method for attaching comprising the steps of:
fixedly attaching an adhesive article according to any one of embodiments 1-20 wherein the discontinuous adhesive layer contacts the first attachment area and the second attachment area and the central portion is positioned over the space to form a fire-resistant joint system; and
placing a thermal barrier between the space and the adhesive article.

Embodiment 30. The method of embodiment 29, wherein the thermal barrier comprises at least one of an intumescent material, mineral fiber, glass fiber, and ceramic fiber.

Embodiment 31. A method of making a firestop system comprising
(a) providing a construction assembly comprising a first major surface and an opposing second major surface and further comprising a first penetration which intersects the first major surface, the first major surface further comprises a first attachment area located about the perimeter of the penetration;
(b) obtaining an adhesive article according to any one of embodiments 1-20;
(c) positioning the central portion over the first penetration;
(d) placing a thermal barrier between the first penetration and the adhesive article; and then
(e) fixedly attaching the distal portions to the first attachment area of the first major surface of the construction assembly to form a firestop system.

Embodiment 32. The method of embodiment 31, wherein the construction assembly further comprises a penetrating object having a second attachment area, wherein the penetrating object passes through the first penetration and extends beyond the first major surface of the construction assembly, and sealing the first penetration by fixedly attaching the distal portions to the first attachment area and the second attachment area.

Embodiment 33. The method of any one of embodiments 31-32, wherein the second major surface of the construction assembly comprises a second penetration which intersects the second major surface of the construction assembly, the second major surface further comprises a third attachment area located about the perimeter of the second penetration; and sealing the second penetration by fixedly attaching the adhesive article to the third attachment area of the second major surface to form a firestop system.

Embodiment 34. The method of embodiment 33, wherein the construction assembly further comprises a penetrating object having a fourth attachment area, wherein the penetrating object passes through the second penetration and extends beyond the second major surface of the construction assembly, and sealing the second penetration by fixedly attaching the adhesive article to the third attachment area and the fourth attachment area.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available or known to those skilled in the art unless otherwise stated or apparent.

The following abbreviations are used: cm=centimeter; gm=gram; in=inch; lb=pound; mm=millimeter; m=meter; and ft=foot.

### Test Methods

### Gypsum Wall Construction

A wall was constructed as a 2 hour fire-rated construction consisting of gypsum board/steel stud assembly constructed of the materials and in the manner described in the individual U400-Series Wall or Partition Design in the UL Fire Resistance Directory (2014) and included the following construction features: Wall framing consisted of steel channel studs. Steel studs were a minimum 3-⅝ in. (92 mm) wide by 1-¼ in. (32 mm) deep with a minimum 25 gauge steel channels. Steel stud spacing was a maximum of 24 in. (610 mm) on center. Two layers ⅝ in. (16 mm) thick gypsum wallboard, as specified in the individual U400-Series Design were used on each side of the wall.

Various sized wall constructions were made, wherein each wall was a box comprising steel studs along the 4 minor sides with a front surface of gypsum board and a back surface of gypsum board. Two or three sections of walls were aligned next to one another to create a linear opening of about 1 in (2.54 cm), unless stated otherwise. A 10.16 cm (4 in.) wide piece of mineral wool (ROXUL Inc., Ontario, Canada) was compressed to fit into the linear opening of the wall. The mineral wool was installed at full depth of the assembly at 15.24 cm (6 in.). The assembly was placed into an external metal frame and secured during testing.

### Fire Test

The construction was tested according to Underwriters Laboratory Inc., Standard for Safety UL 1479 “Fire Tests of Through-Penetration Firestops” (R2012). One side of the construction was exposed to fire at temperatures following UL 1479 for 2 hours.

There are four primary results associated with the testing procedure as outlined in UL 1479: Flexibility, Flame, Temperature, and Hose Stream. For the purposes of these examples, only Flame and Hose Stream were examined.

Flame (F-Rating)—The firestop system was exposed to elevated temperatures (e.g., a controlled fire). The system was required to withstand the fire test for the rating period without permitting the passage of flame through penetration, or the occurrence of flaming on any element of the unexposed side. If any passage of flame or flaming was noted, then the firestop system was rated as “Fail”.

Hose Stream—The firestop system was first exposed to elevated temperatures. After the full two hour flame test, the sample then was exposed to water dispensed through a high pressure fire hose as described in UL 1479 (R2012). A grade of “Pass” was assigned if the installation did not exhibit any tears or loss of adhesion to the construction assembly. The system was said to “Fail” if any tears were observed in the adhesive article, there was a loss of adhesion of the article to the structural element(s) which allowed water to penetrate the opening, or any water transferred beyond the unexposed side of the firestop system.

Materials Table

| Material | Description |
|---|---|
| Tape 06147 | A tape available under the trade designation “SCOTCH |
| | ELECTRICAL MOISTURE SEALANT ROLL 06147” |
| | from 3M Company, St. Paul, MN. |
| Tape 5490 | A tape available under the trade designation |
| | “3M PTFE FILM TAPE 5490” from 3M Company. |
| Tape 8067 | An acrylic pressure sensitive adhesive tape available |
| | under the trade designation “3M ALL-WEATHER |
| | FLASHING TAPE 8067” from 3M Company, having a |
| | total tape thickness of 0.25 mm (0.0099 in) with a |
| | backing thickness of 0.13 mm (0.005 in). |

### EXAMPLES

### Comparative Example 1

A wall was made following the Gypsum Wall Construction above. A wall assembly was constructed with two walls (16 in (406 mm) by 35 in (889 mm)) having a 2 inch (51 mm) width by 35 in (889 mm) linear opening therebetween, which was packed with mineral wool.

Tape 06147 was placed over at least 12 in. (30.5 cm) of the length of the opening on both faces of the wall assembly, overlapping the gypsum wallboard by at least 1.0 in. (2.54 cm) on each side of the opening, such that the adhesive contacted the wall assembly.

The assembly was tested as described in the “Fire Test” test method above. The system passed the Flame test, but during the Hose Stream test, the paper portion of the gypsum wallboard with the attached tape separated from the gypsum core. Thus, the assembly failed the Hose Stream portion of the test.

### Comparative Example 2

Comparative Example 1 was repeated with the following modification. Tape 5490 was used in place of Tape 06147. This assembly provided the same test results as Comparative Example 1.

### Comparative Example 3

Comparative Example 1 was repeated with the following modifications. A modified Tape 8067 was used in place of Tape 06147.

Tape 8067 was modified such that it contained rectangular perforations measuring approximately 0.5 cm by 1.5 cm, wherein the 1.5 cm length opening. There were two rows of perforations located near each lengthwise edge of the tape (i.e., the distal portions of the tape) down its' entire length. The perforations between the two rows were off-set so as to maximize the separation between the perforations between the two rows. No perforations were located down the center lengthwise portion of the tape. The modified tape was placed over at least 12 in. (30.5 cm) of the length of the linear opening on both faces of the wall assembly, overlapping the gypsum wallboard by at least 2.0 in. (5.08 cm) on each side of the opening. The tape was placed such that there were no rectangular perforations located over the opening. The first row of perforations was located approximately 0.5 in. (1.3 cm) from the edge of the linear opening, and the second row was located approximately 1.25 in. (3.2 cm) from the edge of the linear opening The perforations were repeated down the length of the tape approximately every 2.75 in (7.0 cm).

The assembly was tested as described in the “Fire Test” test method above. The system passed the Flame test, but during the Hose Stream test, the paper portion of the gypsum wallboard with the attached tape separated from the gypsum core. Thus, the assembly failed the Hose Stream portion of the test.

### Comparative Example 4

Comparative Example 1 was repeated except that the Tape 06147 was replaced by the following tape.

The tape comprised a 0.005 in (0.13 mm) thick polyolefin film backing. A patterned acrylic adhesive was formed on the backing by dispensing acrylic adhesive in two different pattern across the backing. The first patterned adhesive was a straight line of adhesive which ran parallel to, and down, the entire length of the backing. The lines of first patterned adhesive were approximately 0.5 in (1.3 cm) apart and extended across the width of the backing. The second patterned adhesive was a plurality of sinusoidal lines which were aligned in the longitudinal direction of the backing. The sinusoidal lines had a wavelength of 1.25 in. (3.2 cm) and were approximately 0.5 in (1.3 cm) apart and extended across the width of the backing. The sinusoidal lines contacted the straight lines at the peak and valley of each wavelength. A total of 2 gm of adhesive was used per 4 in (10.2 cm) by 6 in (15.2 cm) area.

The tape was placed over at least 12 in. (30.5 cm) of the length of the linear opening on both sides of the wall assembly, overlapping the gypsum wallboard by at least 2.0 in. (3.08 cm) on each side of the linear opening.

The assembly was tested as described in the “Fire Test” test method above. The system passed the Flame test, but during the Hose Stream test, the paper portion of the gypsum wallboard with the attached tape separated from the gypsum core. Thus, the assembly failed the Hose Stream portion of the test.

### Comparative Example 5

Comparative Example 1 was repeated except that the Tape 06147 was replaced by the following tape.

The tape comprised a 0.005 in. (0.13 mm) thick polyolefin film backing. The backing contained laser cut perforations measuring 500 micrometers in diameter across the entire backing. The perforations were arranged in a hexagonal pattern (i.e., the repeat unit was rectangular in shape and comprised 5 perforations, one at each corner of the repeat unit and one in the middle). The vertical spacing from the midpoint of the perforation located at one corner of the repeat unit to the midpoint of the perforation at the other corner was 10 mm. The horizontal spacing from the midpoint of the perforation located at one corner of the repeat unit to the midpoint of the perforation at the other corner was 5 mm. An acrylic adhesive was dispensed in two different patterns across the backing. The first patterned adhesive was a plurality of sinusoidal shaped lines which were parallel to one another and were aligned in the longitudinal direction of the backing. The sinusoidal line had a wavelength of 1.25 in. (3.2 cm) and the plurality of sinusoidal lines were spaced approximately 0.5 in (1.3 cm) apart across the width of the backing. The second patterned adhesive was a plurality of sinusoidal shaped lines which were parallel to one another and were aligned in the longitudinal direction of the backing. The sinusoidal line had a wavelength of 1.25 in. (3.2 cm) and the plurality of sinusoidal lines were spaced approximately 0.5 in (1.3 cm) apart across the width of the backing. The first and second patterned adhesives overlapped, wherein the sinusoidal lines of the first patterned adhesive were in opposite periodicity to the sinusoidal lines of the second patterned adhesive. In other words, the crest of a first adhesive line overlapped with the valley of a second adhesive line. No care was taken to align the perforations in the backing with the adhesive placement. A total of 2 gm of adhesive was used per 4 in. (10.2 cm) by 6 in. (15.2 cm) area. The tape was placed over at least 12 in. (30.5 cm) of the length of the linear opening on both sides of the wall assembly, overlapping the gypsum wallboard by at least 2.0 in. (3.08 cm) on each side of the opening.

This assembly failed the Flame test portion of the “Fire Test” method described above due to the tape melting and combusting in the area over the opening. Since there was no tape remaining over the opening after the flame test, the hose stream test was not applicable.

### Example 1

Comparative Example 1 was repeated except that the Tape 06147 was replaced by the following tape.

The tape comprised a 0.005 in. (0.13 mm) thick polyolefin film backing. 500 micron perforations were laser cut into the film in a hexagonal spacing where the vertical spacing was 10 mm and the horizontal spacing was 5 mm as described in Comparative Example 5, however, the perforations were only located in the distal portion of the backing, which eventually was attached to the gypsum wallboard. There were no perforations in the central portion of the backing which eventually was positioned over the linear opening of the wall. A patterned acrylic adhesive was applied to the entire backing following perforation. The pattern of the adhesive was similar to that described in Comparative Example 4. No care was taken to align the perforations in the backing with the adhesive placement. A total of 2 g of adhesive was used per 4 in by 6 in area. The sealing strips comprise a line of at least one of the patterned adhesives which did not have perforations between it and opposing sealing strip.

The tape with patterned adhesive and perforations was placed over a minimum of 30.5 cm (12 in.) along the length of the linear opening on both sides of the wall assembly, overlapping the gypsum wallboard by a minimum of 3.08 cm (2.0 in.) on each side of the opening. Care was taken such that the sealing strips were attached to both sides of the linear opening. There are no perforations located over the linear opening.

The assembly passed both the Flame and Hose Stream portions of the “Fire Test” method described above.

A summary of the various examples and test results are shown in Table 1 below.

TABLE 1

| Example | F-Rating | Hose Stream |
|---|---|---|
| CE1 | Pass | Fail |
| CE2 | Pass | Fail |
| CE3 | Pass | Fail |
| CE4 | Pass | Fail |
| CE5 | Fail | NA |
| E1 | Pass | Pass |

NA not applicable

Foreseeable modifications and alterations of this invention will be apparent to those skilled in the art without departing from the scope and spirit of this invention. This invention should not be restricted to the embodiments that are set forth in this application for illustrative purposes.

1. An adhesive article, the adhesive article comprising:
a substrate having a major surface, wherein the major surface has at least two opposing distal portions and a central portion therebetween and wherein the substrate is perforated along the at least two opposing distal portions and is not perforated in the central portion;
(ii) a sealing strip positioned between the central portion and each of the distal portions; and
(iii) a discontinuous adhesive layer disposed on the at least two opposing distal portions.

2. The adhesive article of claim 1, wherein the discontinuous adhesive layer is disposed on the central portion.

3. The adhesive article of claim 1, wherein an intumescent material is fixedly attached to the central portion.

4. The adhesive article of claim 3, wherein the intumescent material is fixedly attached via the discontinuous adhesive layer.

5. The adhesive article of claim 1, wherein the at least two opposing distal portions have an open area of at least 0.01%.

6. The adhesive article of claim 1, wherein the discontinuous adhesive layer comprises at least two different adhesives.

7. The adhesive article of claim 1, wherein the perforations are patterned.

8. The adhesive article of claim 1, wherein the perforations are substantially free of the discontinuous adhesive layer.

9. The adhesive article of claim 1, wherein the adhesive article is an extended length.

10. The adhesive article of claim 1, wherein the central portion is framed by a perforated distal portion.

11. A method of fire protecting an opening, the method comprising:
sealing the opening with the adhesive article of claim 1, wherein the central portion is positioned over the opening and the discontinuous adhesive layer is used to fixedly attach the adhesive article to the perimeter of the opening, wherein a sealing strip is located between the opening and each perforated distal portion of the adhesive article.

12. A method of attaching a fire resistant joint system to a dynamic joint in a structure, the dynamic joint including a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other, the method for attaching comprising the steps of:
fixedly attaching an adhesive article according to claim 1 wherein the discontinuous adhesive layer contacts the first attachment area and the second attachment area and the central portion is positioned over the space to form a fire-resistant joint system; and
placing a thermal barrier between the space and the adhesive article.

13. A method of making a firestop system comprising
(a) providing a construction assembly comprising a first major surface and an opposing second major surface and further comprising a first penetration which intersects the first major surface, the first major surface further comprises a first attachment area located about the perimeter of the penetration;
(b) obtaining an adhesive article according to claim 1;
(c) positioning the central portion over the first penetration;
(d) placing a thermal barrier between the first penetration and the adhesive article; and then
(e) fixedly attaching the distal portions to the first attachment area of the first major surface of the construction assembly to form a firestop system.

14. The adhesive article of claim 1, wherein the discontinuous adhesive layer comprises at least two different adhesives patterns.

15. The adhesive article of claim 1, wherein the discontinuous adhesive layer is a pressure sensitive adhesive.

16. The adhesive article of claim 1, wherein the discontinuous adhesive layer comprises at least one of (i) an acrylic adhesive and (ii) a styrene block copolymer and a tackifier.

17. The adhesive article of claim 1, wherein the adhesive article is an extended length.

18. The adhesive article of claim 1, wherein the central portion is framed by a perforated distal portion.

19. The adhesive article of claim 1, further comprising a liner, wherein the liner is disposed on the discontinuous adhesive layer opposite the substrate.

20. The adhesive article of claim 1, wherein the substrate comprises a release coating on the second major surface of the substrate opposite the discontinuous adhesive layer.
